(19) United States
(12) Patent Application Publication
(10) Pub. No.: US 2025/0306418 A1
(43) Pub. Date: Oct. 2, 2025

(54) DISPLAY DEVICE

(71) Applicant: Japan Display Inc., Tokyo (JP)

(72) Inventor: Tenfu NAKAMURA, Tokyo (JP)

(21) Appl. No.: 19/087,849

(22) Filed: Mar. 24, 2025

(30) Foreign Application Priority Data
Mar. 29, 2024 (JP) 2024-055331

(51) Int. Cl. G02F 1/13357; G02F 1/1335; G02F 1/1339; G02F 1/1343; G02F 1/1362

(52) U.S. Cl. CPC G02F 1/133602; G02F 1/133512; G02F 1/13392; G02F 1/134309; G02F 1/136286

(57) ABSTRACT

According to one embodiment, a display device includes a first substrate having a first transparent substrate and pixel electrodes, a second substrate having a second transparent substrate, a common electrode, and a transparent layer, a liquid crystal layer, and a plurality of light emitting elements arranged along a first direction. The transparent layer includes a first transparent layer including a plurality of grooves arranged along the first direction and extending along a second direction perpendicular to the first direction, a second transparent layer provided in each of the plurality of grooves. The second transparent layer has a refractive index lower than those of the second transparent substrate and the first transparent layer.

### CROSS-REFERENCE TO RELATED APPLICATIONS

This application is based upon and claims the benefit of priority from Japanese Patent Application No. 2024-055331, filed Mar. 29, 2024, the entire contents of which are incorporated herein by reference.

### FIELD

Embodiments described herein relate generally to a display device.

### BACKGROUND

Various display devices using polymer-dispersed liquid crystals that can switch between a scattering state that scatters incident light and a transparent state that transmits incident light have been proposed. In some display devices using polymer-dispersed liquid crystals, the edge-light method, in which a light emitting module is arranged at an edge of the display panel, is used. Such display devices have high transmittance, and therefore they are expected to be used in various fields. On the other hand, there is a demand for improvement in the phenomenon in which the luminance decreases as the distance from the light-emitting module increases in such display devices.

### BRIEF DESCRIPTION OF THE DRAWINGS

FIG. 1 is a plan view showing a configuration example of a display device DSP according to one embodiment.

FIG. 2 is a cross-sectional view showing a configuration example of the display panel PNL shown in FIG. 1.

FIG. 3 is an exploded perspective view showing the main part of the display device DSP shown in FIG. 1.

FIG. 4 is a plan view showing a configuration example of a transparent layer TL shown in FIG. 2.

FIG. 5 is a cross-sectional view showing a configuration example of the display device DSP of this embodiment.

FIG. 6 is a cross-sectional view showing a display panel PNL′ of a comparative example.

FIG. 7 is a diagrammatic illustration illustrating an example of a method of manufacturing a second substrate SUB2 shown in FIG. 2.

FIG. 8 is a diagrammatic illustration illustrating an example of the method of manufacturing the second substrate SUB2 shown in FIG. 2.

FIG. 9 is a diagrammatic illustration illustrating an example of the method of manufacturing the second substrate SUB2 shown in FIG. 2.

FIG. 10 is a diagrammatic illustration illustrating an example of the method of manufacturing the second substrate SUB2 shown in FIG. 2.

### DETAILED DESCRIPTION

In general, according to one embodiment, a display device comprises a first substrate, a second substrate, a liquid crystal layer, and a plurality of light emitting elements arranged along a first direction. The first substrate comprises a first transparent substrate and pixel electrodes disposed in a plurality of pixels, respectively, on the first transparent substrate. The second substrate comprises a second transparent substrate, a common electrode opposing the pixel electrodes, and a transparent layer disposed between the second transparent substrate and the common electrode. The liquid crystal layer contains stripe-shaped polymers and liquid crystal molecules, and is disposed between the first substrate and the second substrate. The transparent layer comprises a first transparent layer having a plurality of grooves arranged along the first direction and extending along a second direction perpendicular to the first direction, and a second transparent layer provided in each of the plurality of grooves. Each of the plurality of grooves has an aperture opposing the liquid crystal layer. The second transparent layer has a refractive index lower than those of the second transparent substrate and the first transparent layer.

According to another embodiment, a display device comprises a first substrate, a second substrate, a liquid crystal layer, and a plurality of light emitting elements arranged along a first direction. The first substrate comprises a first transparent substrate and pixel electrodes disposed in a plurality of pixels, respectively, on the first transparent substrate. The second substrate comprises a second transparent substrate, a common electrode opposing the pixel electrodes, and a transparent layer disposed between the second transparent substrate and the common electrode. The liquid crystal layer contains stripe-shaped polymers and liquid crystal molecules, and is disposed between the first substrate and the second substrate. The transparent layer comprises a first transparent layer having a plurality of grooves arranged along the first direction and extending along a second direction perpendicular to the first direction, and a second transparent layer provided in each of the plurality of grooves. The first transparent layer is formed of an inorganic material. The second transparent layer is formed of an organic material. The second transparent layer has a refractive index lower than those of the second transparent substrate and the first transparent layer.

According to the configurations described above, it is possible to provide a display device that can suppress a decrease in display quality.

Embodiments will be described hereinafter with reference to the accompanying drawings.

Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

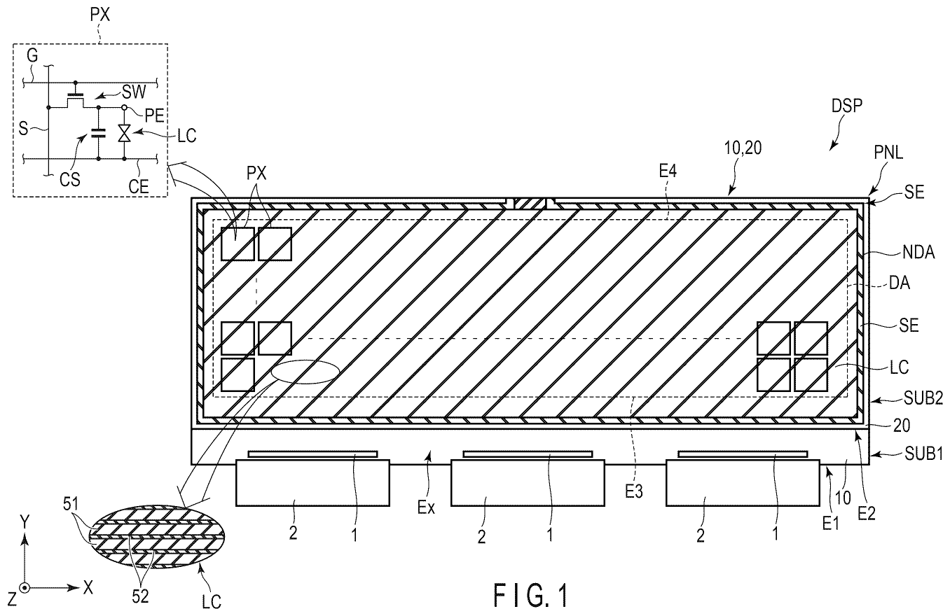

FIG. 1 is a plan view showing a configuration example of a display device DSP of this embodiment. For example, a first direction X, a second direction Y, and a third direction Z are orthogonal to each other, but they may intersect at an angle other than 90 degrees. The first direction X and the second direction Y correspond to directions parallel to a main surface of the substrates that constitute the display device DSP, and the third direction Z corresponds to the thickness direction of the display device DSP. In this specification, the direction from a first substrate SUB1 towards a second substrate SUB2 is referred to as the “upper side” (or simply “upper” or “above”), and the direction from the second substrate SUB2 towards the first substrate SUB1 is referred to as the “lower side” (or simply “lower” or “below”). Further, with such expressions “a second member above a first member” and “a second member below a first member”, the second member may be in contact with the first member or may be remote from the first member. In addition, it is assumed that there is an observation position to observe the display device DSP on a tip side of an arrow indicating the third direction Z, and viewing from this observation position toward the X-Y plane defined by the first direction X and the second direction Y is referred to as plan view.

In this embodiment, as an example of display devices DSP, a liquid crystal display device in which polymer-dispersed liquid crystals are applied will be explained. The display device DSP comprises a display panel PNL, IC chips 1, and wiring substrates 2.

The display panel PNL comprises a first substrate SUB1, a second substrate SUB2, a liquid crystal layer LC, and a seal SE. The first substrate SUB1 and the second substrate SUB2 are formed into a flat plate shape parallel to the X-Y plane. The first substrate SUB1 and the second substrate SUB2 overlap each other in plan view. The first substrate SUB1 and the second substrate SUB2 are adhered together by the seal SE.

The first substrate SUB1 includes an edge portion E1 that extends along the first direction X. The second substrate SUB2 includes an edge portion E2 that extends along the first direction X. Note that the edge portion E2 does not overlap the edge portion E1 in plan view. The first substrate SUB1 includes an extending portion Ex that extends from the edge portion E2 in the second direction Y in plan view. Note that the extending portion Ex does not overlap the second substrate SUB2 in plan view.

The liquid crystal layer LC is held between the first substrate SUB1 and the second substrate SUB2 and sealed by the seal SE. In FIG. 1, the liquid crystal layer LC and the seal SE are illustrated by different slash lines.

As shown enlarged in a schematic view of FIG. 1, the liquid crystal layer LC comprises a polymer-dispersed liquid crystal that includes polymers 51 and liquid crystal molecules 52. In one example, the polymers 51 are liquid crystal polymers. The polymers 51 are formed into a strip shape elongated along the first direction X. The liquid crystal molecules 52 are dispersed in the gaps of the polymers 51 and aligned so as to set their longitudinal axes along the first direction X. Each of the polymers 51 and the liquid crystal molecules 52 has optical anisotropy or refractive index anisotropy. The response of the polymers 51 to an electric field is lower than the response of the liquid crystal molecules 52 to an electric field.

In one example, the alignment direction of the polymers 51 does not substantially change regardless of the presence or absence of an electric field. On the other hand, the alignment direction of the liquid crystal molecules 52 changes in response to the electric field when a voltage at or above the threshold is being applied to the liquid crystal layer LC. When no voltage is being applied to the liquid crystal layer LC, the optical axes of the polymers 51 and the liquid crystal molecules 52 are parallel to each other, and light that enters the liquid crystal layer LC is transmitted without substantially being scattered in the liquid crystal layer LC (transparent state). When a voltage is being applied to the liquid crystal layer LC, the optical axes of the polymers 51 and the liquid crystal molecules 52 intersect each other, and the light that enters the liquid crystal layer LC is scattered within the liquid crystal layer LC (scattering state).

The display panel PNL comprises a display area DA for displaying images and a frame-shaped non-display area NDA surrounding the display area DA in an area where the first substrate SUB1 and the second substrate SUB2 overlap each other in plan view. The seal SE is located in the non-display area NDA. The display area DA comprises pixels PX arranged in a matrix pattern along the first direction X and the second direction Y. The display area DA includes edge portions E3 and E4 that extend along the first direction X. The edge portion E3 is located between the edge portion E2 and the edge portion E4 in the second direction Y.

As shown in an enlarged view in FIG. 1, each of the pixels PX comprises a switching element SW, a pixel electrode PE, a common electrode CE, a liquid crystal layer LC, and so on. The switching element SW is configured, for example, by a thin film transistor (TFT) and is electrically connected to a respective scanning lines G and a respective signal lines S. The scanning lines G each extend along the first direction X and are electrically connected to the switching element SW of each respective one of the pixels PX aligned along the first direction X. The signal lines S each extend along the second direction Y, intersect with the scanning lines G, and are electrically connected to the switching element SW of each respective one of the pixels PX aligned along the second direction Y. The pixel electrodes PE are each electrically connected to a respective one of the switching elements SW. Each of the pixel electrodes PE opposes the common electrode CE, and the liquid crystal layer LC (in particular, the liquid crystal molecules 52) is driven by the electric field generated between the pixel electrodes PE and the common electrode CE. A capacitance CS is formed, for example, between an electrode having the same potential as that of the common electrode CE and an electrode having the same potential as that of the pixel electrode PE.

The IC chips 1 and the wiring substrates 2 are each connected to the extending portion Ex. The IC chips 1 each contain, for example, a display driver built therein, that outputs signals necessary for image display. The wiring substrates 2 are flexible printed circuit boards that can be bent. Note that the IC chips 1 may as well be connected to the wiring substrates 2. The IC chips 1 and the wiring substrates 2 read signals from the display panel PNL in some cases, but they mainly function as signal sources that supply signals to the display panel PNL.

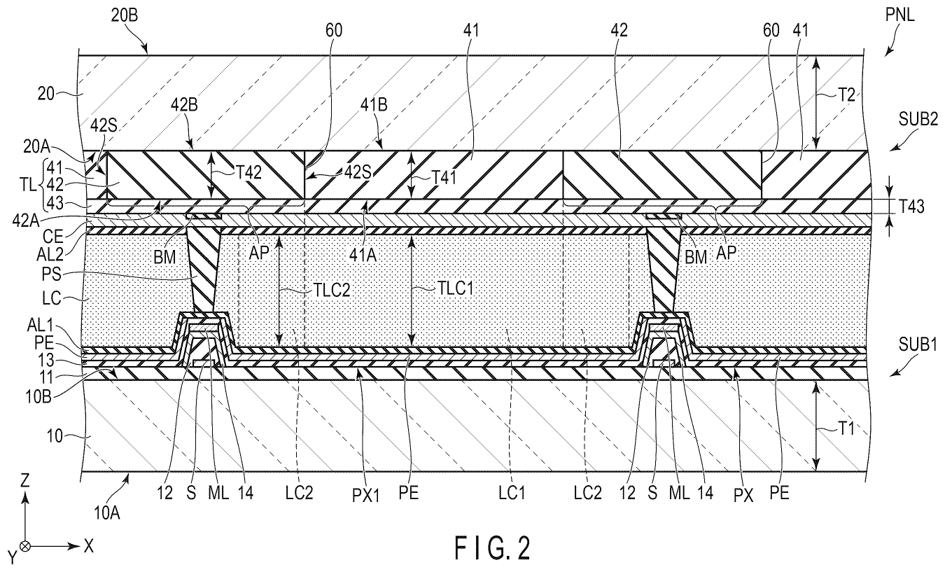

FIG. 2 is a cross-sectional view showing a configuration example of the display panel PNL shown in FIG. 1. Here, the cross-section of the display area DA in the X-Z plane defined by the first direction X and the third direction Z will be explained.

The first substrate SUB1 comprises a transparent substrate 10, insulating films 11, 12 and 13, a capacitive electrode 14, metal lines ML, signal lines S, pixel electrodes PE, and an alignment film AL1. Further, the first substrate SUB1 comprises switching elements SW and scanning lines G shown in FIG. 1. The scanning lines G are disposed, for example, between the transparent substrate 10 and the insulating film 11.

The transparent substrate 10 comprises a main surface (lower surface) 10A and a main surface (upper surface) 10B on an opposite side to the main surface 10A. The main surfaces 10A and 10B are surfaces that are substantially parallel to the X-Y plane. The insulating film 11 covers the main surface 10B. The signal lines S are disposed on the insulating film 11.

The insulation film 12 covers the signal lines S. Although it is not described in detail, the insulation film 12 is formed into a grid pattern that overlaps the scanning lines G and the signal lines S. The capacitive electrode 14 is disposed on the insulation film 12. The metal lines ML are disposed on the capacitive electrode 14. Although it is not described in detail, the capacitive electrode 14 and the metal lines ML are formed into a grid pattern that overlaps the insulation film 12.

The insulating film 13 covers the insulating film 11, the capacitive electrode 14 and the metal lines ML. The capacitive electrode 14 is provided between the insulating films 12 and 13. The pixel electrode PE is provided between the insulating film 13 and the alignment film AL1, and is provided for each pixel PX. The pixel electrode PE is electrically connected to the switching element SW. The pixel electrode PE opposes the capacitive electrode 14 via the insulating film 13, and forms the capacitance CS of the pixel PX. The alignment film AL1 covers the pixel electrodes PE and the insulating film 13. The alignment film AL1 covers the capacitive electrode 14 and the metal lines ML, which overlap the insulating film 12 between each adjacent pair of pixels PX, that is, in the regions where the signal lines S, the scanning lines G, and the switching elements SW are provided.

The second substrate SUB2 comprises a transparent substrate 20, a transparent layer TL, light shielding layers BM, a common electrode CE, an alignment film AL2, and spacers PS.

The transparent substrate 20 comprises a main surface (lower surface) 20A and a main surface (upper surface) 20B on an opposite side to the main surface 20A. The main surfaces 20A and 20B are surfaces that are substantially parallel to the X-Y plane. The main surface 20A of the transparent substrate 20 opposes the main surface 10B of the transparent substrate 10.

The transparent layer TL is disposed between the transparent substrate 20 and the common electrode CE. In the example shown in the figure, the transparent layer TL is formed on the main surface 20A of the transparent substrate 20. The transparent layer TL comprises a first transparent layer 41, second transparent layers 42, and a third transparent layer 43.

The first transparent layer 41 is disposed between the transparent substrate 20 and the common electrode CE. In the example shown in FIG. 2, the first transparent layer 41 is disposed between the transparent substrate 20 and the third transparent layer 43, and is formed on the main surface 20A of the transparent substrate 20. The first transparent layer 41 includes a surface 41A opposing the liquid crystal layer LC and a surface 41B in contact with the main surface 20A.

The first transparent layer 41 includes a plurality of grooves 60. The plurality of grooves 60 are each arranged along the first direction X and extend along the second direction Y. Each of the grooves 60 has an aperture AP. The aperture AP is formed to oppose the liquid crystal layer LC. In the example shown in FIG. 2, each of the grooves 60 penetrates the first transparent layer 41 along the third direction Z. In other words, a portion of the main surface 20A of the transparent substrate 20 is exposed from the first transparent layer 41 in the grooves 60. Note that each of the grooves 60 may not penetrate the first transparent layer 41 along the third direction Z and may have a bottom portion. In this case, in the bottom portion of each of the grooves 60, the main surface 20A of the transparent substrate 20 is not exposed from the first transparent layer 41. In the example shown in FIG. 2, the grooves 60 are each located directly above the respective signal line S along the third direction Z, and overlap the signal lines S in plan view. The details of the shape of the grooves 60 will be described later.

The second transparent layers 42 are each located in the respective one of the grooves 60 and are disposed between the transparent substrate 20 and the common electrode CE. In the example shown in FIG. 2, the second transparent layers 42 are disposed between the transparent substrate 20 and the third transparent layer 43. The second transparent layers 42 are aligned along the first direction X and each extend along the second direction Y. The first transparent layer 41 and the second transparent layers 42 are arranged alternately along the first direction X. The second transparent layers 42 have a planar shape the same as that of the grooves 60. The details of the shape of the second transparent layers 42 will be described later.

In the example shown in FIG. 2, the second transparent layers 42 are each in contact with the transparent substrate 20, the first transparent layer 41, and the third transparent layer 43. The second transparent layers 42 each have a surface 42A in contact with the third transparent layer 43 and opposing the liquid crystal layer LC, a surface 42B in contact with the main surface 20A, and side surfaces 42S in contact with the first transparent layer 41. In the example shown in FIG. 2, the side surfaces 42S extend along the third direction Z, but they may extend in a direction different from the third direction Z.

In the example shown in FIG. 2, the second transparent layers 42 are each located directly above the respective signal lines S, and each overlap the signal line S in plan view. Further, the second transparent layers 42 are each located directly above the respective light shielding layers BM, and each overlap the respective light shielding layers BM in plan view. Furthermore, the second transparent layers 42 are each located directly above the respective spacers PS, and each overlap the spacer PS in plan view.

The third transparent layer 43 is arranged between the first transparent layer 41 and the second transparent layers 42, and the common electrode CE. The third transparent layer 43 directly covers the surface 41A of the first transparent layer 41 and the surfaces 42A of the second transparent layers 42. The second transparent layers 42 are in contact with the transparent substrate 20, the transparent layer 41, and the third transparent layer 43. The third transparent layer 43 further planarizes the surface 41A of the first transparent layer 41 and the surfaces 42A of the second transparent layers 42.

The first transparent layer 41 has a thickness T41, except in the regions where the grooves 60 are provided. The second transparent layers 42 have a thickness T42, which is, for example, 1 μm or more. The thickness T41 is equivalent to the thickness T42, and is, for example, 1 μm or more. The third transparent layer 43 has a thickness T43. The thickness T43 is, for example, about 1 μm. Note that the term “thickness” used in this specification corresponds to the length along the third direction Z.

The light shielding layers BM are provided between the transparent layer TL and the liquid crystal layer LC. In the example shown in FIG. 2, the light shielding layers BM are provided between the transparent layer TL and the common electrode CE. The light shielding layers BM are each located, for example, directly above the respective signal lines S, and directly above the respective switching elements SW and the respective scanning lines G, which are not shown in the figure.

The common electrode CE is provided between the transparent layer TL and the alignment film AL2. The common electrode CE covers the transparent layer TL and the light shielding layers BM. In the example shown in FIG. 2, the common electrode CE covers the third transparent layer 43 and the light shielding layers BM. The common electrode CE is arranged over multiple pixels PX and opposes each of the pixel electrodes PE via the liquid crystal layer LC along the third direction Z. The common electrode CE is electrically connected to the capacitive electrode 14 and has the same potential as that of the capacitive electrode 14.

The spacers PS are disposed on the surface of the common electrode CE opposing the liquid crystal layer LC, and penetrates the liquid crystal layer LC so as to be in contact with the alignment film AL1. The spacers PS are each located, for example, directly above the respective signal lines S, and directly above the respective switching elements SW and the respective scanning lines G, which are not shown in the figure.

The alignment film AL2 covers the common electrode CE.

The liquid crystal layer LC is provided between the first substrate SUB1 and the second substrate SUB2, and is in contact with the alignment films AL1 and AL2. Here, the liquid crystal layer LC of one pixel PX1 will be focused. The liquid crystal layer LC includes a region LC1 that does not overlap the second transparent layers 42 in plan view, and a region LC2 that does overlap the second transparent layers 42 in plan view. The region LC1 has a thickness TLC1. The region LC2 has a thickness TLC2. The thickness TLC1 of the region LC1 is equivalent to the thickness TLC2 of the region LC2. In one example, the thickness TLC1 and the thickness TLC2 are about 3 μm.

In the first substrate SUB1, the insulating films 11, 12 and 13, the capacitive electrode 14, the signal lines S, the pixel electrodes PE, and the alignment film AL1 are located between the main surface 10B and the liquid crystal layer LC. On the second substrate SUB2, the light shielding layers BM, the common electrode CE, and the alignment film AL2 are located between the transparent layer TL and the liquid crystal layer LC.

The transparent substrates 10 and 20 are insulating substrates such as glass substrates, plastic substrates or the like. The insulating film 11 is an inorganic insulating film formed from silicon oxide, silicon nitride, silicon oxynitride or the like. The insulating film 12 is an organic insulating film formed from, for example, acrylic resin or the like. The insulating film 13 is an inorganic insulating film formed from silicon nitride.

The capacitive electrode 14, the pixel electrodes PE, and the common electrode CE are transparent electrodes formed from transparent conductive materials such as indium tin oxide (ITO) or indium zinc oxide (IZO).

The alignment films AL1 and AL2 are horizontal alignment films that have an alignment restriction force that is substantially parallel to the X-Y plane. In one example, the alignment films AL1 and AL2 are subjected to an alignment treatment along the first direction X. Note that the alignment treatment may be a rubbing treatment or an optical alignment treatment.

The light shielding layers BM may each be an optical absorption layer formed from a material having light absorption properties, or it may be an optical reflection layer formed from a material having light reflection properties. Further, the light shielding layer BM may each also be an insulating layer formed from an inorganic material or an organic material, or it may be a conductive layer formed from a metal material.

The first transparent layer 41 is inorganic film formed from an inorganic material such as silicon dioxide. The second transparent layers 42 are formed from an organic material such as siloxane-based resin or fluorine-based resin. The third transparent layer 43 is formed from an organic material that is different from that of the second transparent layer 42. The third transparent layer 43 is an organic insulating film formed from, for example, an organic material such as acrylic resin.

The transparent substrate 10 has a thickness T1, and the transparent substrate 20 has a thickness T2. In the example illustrated, the thickness T1 is equal to the thickness T2.

The transparent substrate 20, the first transparent layer 41, and the third transparent layer 43 have a refractive index n1. The second transparent layers 42 have a refractive index n2 that is lower than the refractive index n1. The refractive index n1 is about 1.5, and the refractive index n2 is about 1.0 to 1.4.

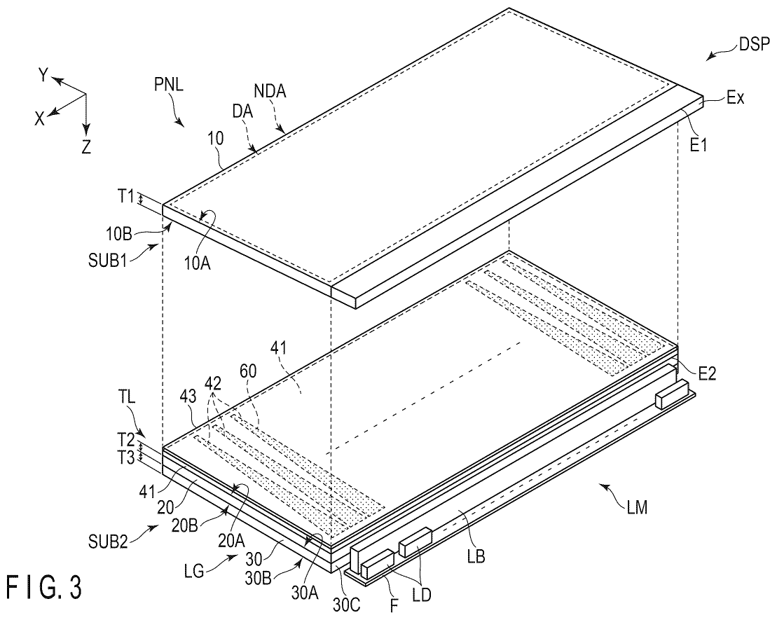

FIG. 3 is an exploded perspective view showing the main part of the display device DSP shown in FIG. 1. In FIG. 3, the first transparent layer 41, the second transparent layers 42, and the grooves 60 are illustrated by dotted lines which pass therethrough.

In addition to the display panel PNL, the display device DSP comprises a light guide element LG and a light emitting module LM. The first substrate SUB1, the second substrate SUB2, and the light guide element LG are arranged in this order along the third direction Z.

The light emitting module LM comprises a plurality of light emitting elements LD, a light guide body LB, and a wiring substrate F.

The light emitting elements LD are arranged at intervals along the first direction X. Each of the light emitting elements LD is connected to the wiring substrate F. In the example shown in FIG. 3, each of the light emitting elements LD overlaps the extending portion Ex in plan view. The light emitting element LD is, for example, a light-emitting diode. The light emitting element LD, though will not be described in detail, comprises a red light-emitting portion, a green light-emitting portion, and a blue light-emitting portion. The light emitted from the light emitting element LD proceeds along a direction of the arrow indicating the second direction Y.

The light guide body LB is formed into a rod shape elongated along the first direction X, and is placed between the light emitting elements LD and the light guide element LG along the second direction Y.

The light guide element LG comprises a transparent substrate 30.

The transparent substrate 30 comprises a main surface (lower surface) 30A and a main surface (upper surface) 30B on an opposite side to the main surface 30A. The main surfaces 30A and 30B are surfaces that are substantially parallel to the X-Y plane. The main surface 30A opposes the main surface 20B of the transparent substrate 20.

The transparent substrate 30 has a side surface 30C. The side surface 30C is a plane that is substantially parallel to the X-Z plane defined by the first direction X and the third direction Z. The side surface 30C is located on a side opposing the light emitting element LD in plan view. The side surface 30C opposes the plurality of light emitting elements LD via the light guide body LB along the second direction Y.

The transparent substrate 30 is adhered to the transparent substrate 20. In the example shown in FIG. 3, the side surface 30C is located directly below the edge portion E2 of the second substrate SUB2, but it may as well be located directly below the extending portion Ex, or it may be located on a further outer side with respect to the edge portion E1.

The transparent substrate 30 is an insulating substrate. The transparent substrate 30 is, for example, a glass substrate, but it may as well be a plastic substrate made of polymethyl methacrylate (PMMA) or polycarbonate (PC). In one example, the transparent substrate 30 is a single substrate, not a substrate made by adhering multiple substrates together.

The transparent substrate 30 has a thickness T3. In one example, the thickness T3 is greater than the thickness T1 of the transparent substrate 10 and the thickness T2 of the transparent substrate 20. Note that the thickness T3 may be equivalent to the thicknesses T1 and T2. In one example, the thickness T3 is 200 μm to 2,000 μm.

The refractive index of the transparent substrate 30 is equivalent to the refractive index n1 of the transparent substrate 20, the first transparent layer 41, and the third transparent layer 43, and is higher than the refractive index n2 of the second transparent layers 42. The expression “equivalent” here does not only refer to the case where the refractive index difference is zero, but also includes the case where the refractive index difference is 0.03 or less.

In the example shown in the figure, the plurality of grooves 60 and the second transparent layers 42 each overlap the display area DA in plan view.

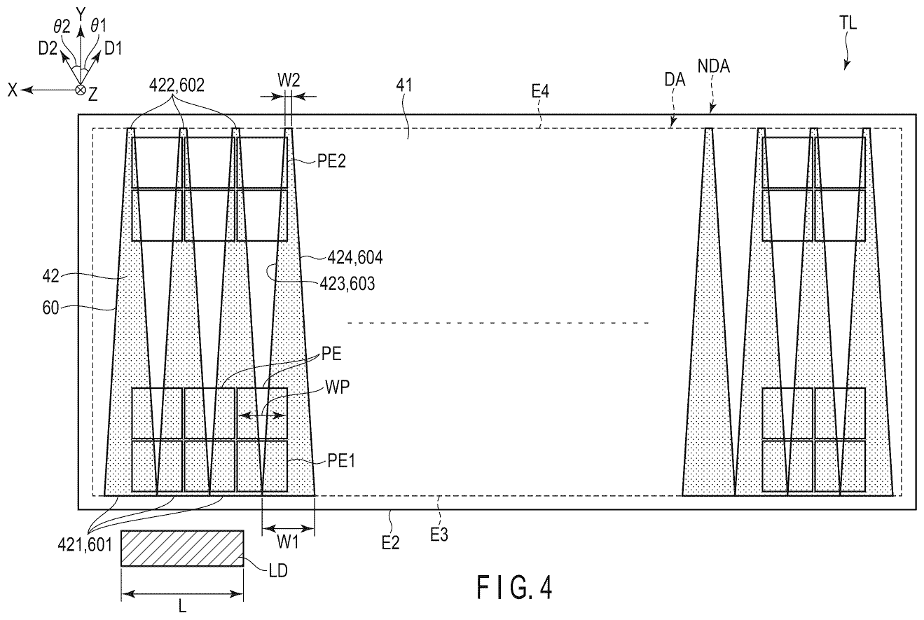

FIG. 4 is a plan view showing a configuration example of the transparent layer TL shown in FIG. 3. In FIG. 4, the third transparent layer 43 is omitted. Further, FIG. 4 schematically shows an enlarged view of the grooves 60 and the second transparent layers 42 in terms of the width along the first direction X. Further, in FIG. 4, the region that overlaps the display area DA is indicated by dotted lines.

The grooves 60 each comprise a first end portion 601 on a side opposing the light emitting element LD, a second end portion 602 on an opposite side to the first end portion 601, a first edge 603, and a second edge 604. The grooves 60 are each disposed along the first direction X and extend along the second direction Y. Each of the first end portions 601 is disposed on the same straight line along the first direction X. In the example shown in FIG. 4, each of the first end portions 601 overlaps the edge portion E3 of the display area DA in plan view, and each of the second end portions 602 overlaps the edge portion E4 of the display area DA in plan view, but the configuration is not limited to this. From the perspective of suppressing light leakage between the edge portion E2 of the second substrate SUB2 and the display area DA, it is desirable that each of the first end portions 601 should be in close proximity to the light emitting element LD beyond the display area DA.

The first end portions 601 have a first width W1, whereas the second end portions 602 have a second width W2. Note that the term “width” used in this specification corresponds to the length along the first direction X. The first width W1 is greater than the second width W2. In one example, the first width W1 is less than a width L of a single light emitting element LD, and a single light emitting element LD is arranged across multiple grooves 60 aligned along the first direction X. Further, the first width W1 is equivalent to or less than a width WP (or the pitch of the pixel electrodes PE aligned along the first direction X) of a single pixel electrode PE. For all grooves 60, the first width W1 and the second width W2 are approximately the same as each other.

The first edge 603 and the second edge 604 extend in a direction different from the first direction X and the second direction Y between the first end portion 601 and the second end portion 602. For example, the direction that intersects at an acute angle clockwise with respective to the second direction Y is defined as a direction D1, and the direction that intersects at an acute angle counterclockwise with respective to the second direction Y is defined as a direction D2. Note that an angle θ1 made between the second direction Y and direction D1, and an angle θ2 made between the second direction Y and the direction D2 are the same as each other. But the configuration is not limited to this, and the angle between the second direction Y and the direction D1 and the angle between the second direction Y and the direction D2 may be different from each other.

The first edge 603 extends along the direction D1, and the second edge 604 extends along the direction D2. Here, the first edge 603 and the second edge 604 extend both linearly, but they may as well be formed into a curved shape. The first width W1 and the second width W2 correspond to the distance between the first edge 603 and the second edge 604 along the first direction X.

The grooves 60 of such a shape have a width that gradually decreases at a constant rate or at an arbitrary rate as the location approaches from the first end portion 601 towards the second end portion 602. It is desirable that the pitch between each adjacent pair of the grooves 60 should be twice or less than a width WP of the pixel electrodes PE (or the pitch of the pixel electrodes PE aligned along the first direction X).

On the plurality of grooves 60, the second transparent layers 42 are formed respectively. The second transparent layers 42 have a planar shape the same as that of the grooves 60. That is, the second transparent layers 42 each have a first end portion 421 on the side opposing the light emitting element LD, a second end portion 422 on the opposite side to the first end portion 421, a first edge 423, and a second edge 424. The second transparent layers 42 are aligned along the first direction X and each extend along the second direction Y. The second transparent layers 42 each have a width that gradually decreases at a constant rate or at an arbitrary rate as the location approaches from the first end portion 421 towards the second end portion 422.

The first transparent layer 41 is provided between each adjacent pair of the second transparent layers 42. The pixel electrodes PE each overlap each adjacent pair of the second transparent layers 42 (or the grooves 60) in plan view. The pixel electrodes PE overlap the first transparent layer 41 between each respective adjacent pair of the second transparent layers 42.

In the display area DA, the pixel electrode PE1 that is closest to the light emitting element LD and the pixel electrode PE2 that is furthest from the light emitting element LD will now be focused. The area of the region of the pixel electrode PE1 that overlaps the second transparent layers 42 is greater than the area of the region of the pixel electrode PE2 that overlaps the second transparent layers 42. In other words, the area where the first transparent layer 41 and the pixel electrode PE1 overlap each other is less than the area where the first transparent layer 41 and the pixel electrode PE2 overlap. Thus, in the region close to the light emitting element LD, the overlapping area between the pixel electrode PE and the second transparent layers 42 is larger as compared to the region distant from the light emitting element LD.

As will be explained later, the region overlapping the second transparent layers 42 corresponds to the region where substantially no light from the light emitting element LD enters the display panel PNL, and the region overlapping the first transparent layer 41 corresponds to the region where light from the light emitting element LD can enter the display panel PNL.

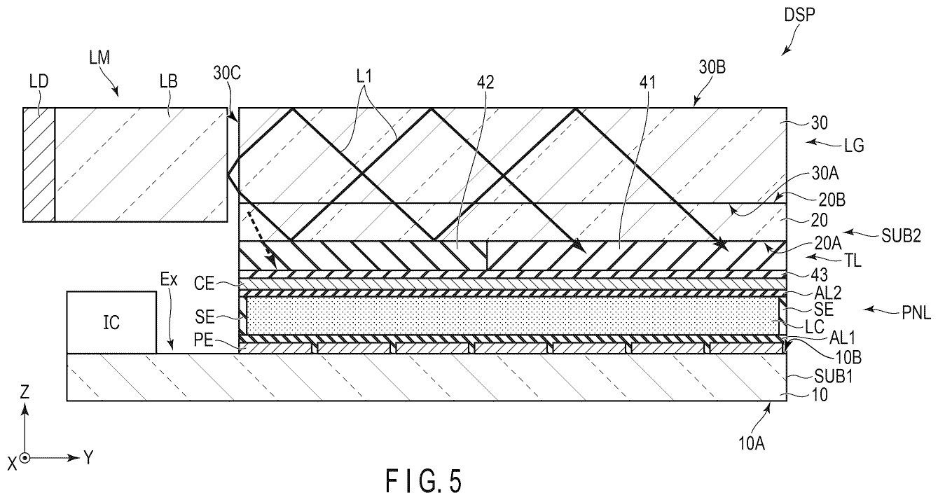

FIG. 5 is a cross-sectional view showing a configuration example of the display device DSP shown in FIG. 1. Note that as to the display panel PNL, only the main parts thereof are shown. With reference to FIG. 5, the emission light from the light emitting elements LD will be explained.

The light emitting elements LD each emit light L1 towards the side surface 30C of the transparent substrate 30. The light L1 emitted from the light emitting element LD passes through the light guide LB, and thereafter is refracted at the side surface 30C. Then, the light enters the transparent substrate 30 and the transparent substrate 20. Of the light L1 that enters the transparent substrate 20, part of the light that proceeds towards the respective second transparent layers 42 is reflected at the interface between the transparent substrate 20 and the second transparent layer 42, and does not reach the liquid crystal layer LC or the first substrate SUB1. On the other hand, of the light that proceeds from the transparent substrate 20 towards the second transparent layer 42, the portion of the light that has an incident angle smaller than the critical angle passes through the second transparent layer 42 and reaches the liquid crystal layer LC and the first substrate SUB1, as indicated by the broken lines.

Further, of the light L1 that enters the transparent substrate 30, the portion of the light that proceeds towards the main surface 30B is reflected at the interface between the transparent substrate 30 and the air layer. As described above, in the vicinity of the side surface 30C (or in the region where the second transparent layer 42 is present), most of the light L1 proceeds through inside the transparent substrate 30 and the transparent substrate 20 while being repeatedly reflected. Of the proceeding light L1, the portion of the light that proceeds towards the region where the second transparent layer 42 does not exist passes through the first transparent layer 41 and reaches the liquid crystal layer LC and the first substrate SUB1.

In the liquid crystal layer LC of the pixel to which voltage is being applied, the light L1 is scattered. On the other hand, in the liquid crystal layer LC of the pixel to which voltage is not being applied, the light L1 passes therethrough. The display device DSP can be observed from the main surface 10A side, and it can be observed from the main surface 30B side as well. Further, whether the display device DSP is observed from the main surface 10A side or the main surface 30B side, the background of the display device DSP can be observed via the display device DSP.

According to this embodiment, it is possible to suppress a decrease in the display quality of the display panel PNL.

When the luminance distribution of the light L1 from the light emitting element LD is focused, the luminance tends to decrease in the region that is distant from the light emitting element LD. One of the factors of this decrease in luminance is the undesired absorption and scattering of the light L1 by the liquid crystal layer LC, signal lines S, various insulating films, and the like.

The region where the second transparent layers 42 overlap the pixel electrodes PE corresponds to the region where substantially no light L1 from the light emitting elements LD enters the display panel PNL, and the region where the second transparent layers 42 do not overlap the pixel electrodes PE (or the region between respective adjacent pairs of second transparent layers 42) corresponds to the region where the light L1 from the light emitting elements LD enters the display panel PNL.

In the region in the vicinity of the light emitting element LD, the overlapping area of the second transparent layers 42 per pixel electrode PE is greater than that of the region distant from the light emitting element LD. Therefore, in the region in the vicinity of the light emitting element LD, the entering of the light L1 into the display panel PNL is suppressed, and the absorption and scattering of the light L1 by the liquid crystal layer LC, signal lines S, various insulating films and the like are suppressed. On the other hand, in the region distant from the light emitting element LD, the entering of the light L1 into the display panel PNL is promoted. As described above, the light from the light emitting element LD attenuates as the location becomes more distant from the light emitting element LD. The overlapping area between the pixel electrode PE1 and the second transparent layers 42 shown in FIG. 4 is greater than the overlapping area between the pixel electrode PE2 and the second transparent layers 42. With this configuration, the area of the region where the light L1 can enter the pixel electrode PE1 is less than the area of the region where the light L1 can enter the pixel electrode PE2. On the other hand, the intensity of the light entering the pixel electrode PE1 is higher than the intensity of the light entering the pixel electrode PE2. Thus, the luminance of the display panel PNL at the pixel electrode PE1 and the pixel electrode PE2 can be equalized.

The display device DSP scatters the light L1 that enters the liquid crystal layer LC by applying an electric field to the liquid crystal layer LC to change the alignment direction of the liquid crystal molecules. When the thickness of the liquid crystal layer LC is uneven, the strength of the electric field being applied to the liquid crystal layer LC becomes uneven as well, possibly causing the deterioration of the display quality of the display panel PNL.

The second transparent layer 42 has a thickness greater than or equal to such a certain level as to reflect the light L1. When the second transparent layers 42 are provided in the display panel PNL, the thickness of the second transparent layers 42 may cause the thickness of the liquid crystal layer LC to become uneven.

The second transparent layers 42 are provided respectively in the plurality of grooves 60 of the first transparent layer 41. With this configuration, in the transparent layer TL, the difference in thickness between the region where the second transparent layers 42 are provided (the region where the entering of the light L1 into the display panel PNL is suppressed) and the region where the second transparent layers 42 are not provided (the region where the light L1 enters the display panel PNL) can be reduced and the alignment film AL2 provided on the transparent layer TL can be planarized. Thus, the distance between the alignment film AL1 and the alignment film AL2, that is, the thickness of the liquid crystal layer LC, can be made even.

In this manner, according to this embodiment, the non-uniformity of the luminance of the display panel PNL can be suppressed and the non-uniformity of the thickness of the liquid crystal layer LC can be suppressed. Therefore, it is possible to suppress the degradation of the display quality of the images displayed on the display panel PNL.

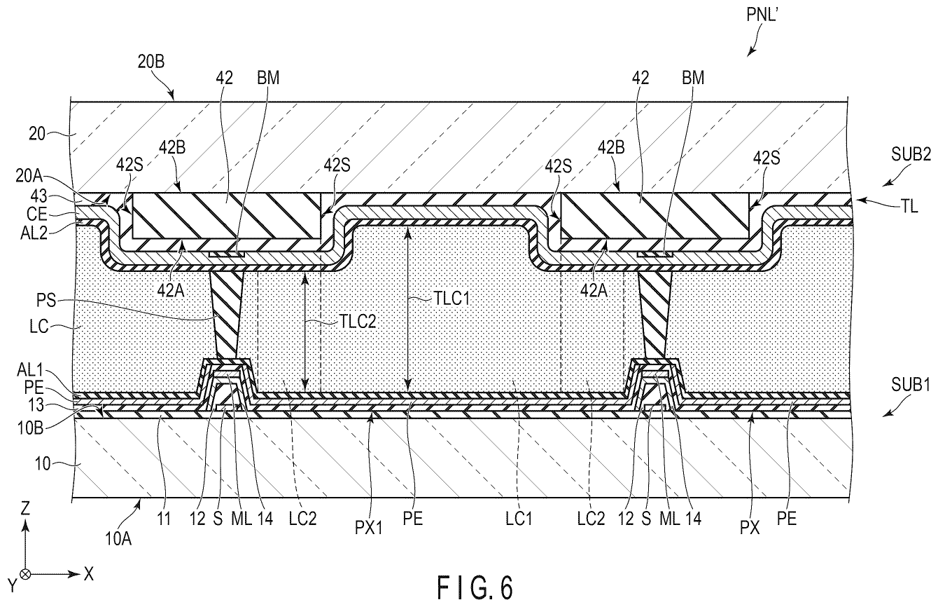

FIG. 6 shows a cross-sectional view showing a display panel PNL′ of a comparative example. The display panel PNL′ of the comparative example is different from the display panel PNL in that the transparent layer TL includes only the second transparent layers 42 and the third transparent layer 43, and does not have the first transparent layer 41.

In the comparative example shown in FIG. 6, the second transparent layers 42 are disposed on the main surface 20A of the transparent substrate 20. The second transparent layers 42 are aligned along the first direction X and each extend along the second direction Y. The third transparent layer 43 covers the surfaces 42A and side surfaces 42S of the second transparent layers 42 and covers the main surface 20A between each adjacent pair of the second transparent layers 42. In the transparent layer TL, the region where the second transparent layers 42 are provided protrudes toward a liquid crystal layer LC side. That is, in the transparent layer TL, the thickness of the region where the second transparent layers 42 are provided (the region where the entering of the light L1 into the display panel PNL is suppressed) is greater than the thickness of the region where the second transparent layers 42 are not provided (the region where the light L1 enters the display panel PNL).

In the common electrode CE and the alignment film AL2 formed on the transparent layer TL having such a cross-sectional shape, the region opposing the second transparent layers 42 protrudes toward a liquid crystal layer LC side further from the region not opposing the second transparent layers 42. With this configuration, in the liquid crystal layer LC, a thickness TLC2 of the region LC2 opposing the second transparent layer 42 is less than a thickness TLC1 of the region LC1 no opposing the second transparent layer 42, and the thickness of the liquid crystal layer LC becomes uneven.

In the display panel PNL′ such as that of the comparative example shown in FIG. 6, when voltage is being applied to the liquid crystal layer LC, in the region LC2 of the liquid crystal layer LC, which opposes the second transparent layer 42, the electrical potential distribution becomes dense, whereas in the region LC1 which does not oppose the second transparent layer 42, the electrical potential distribution becomes sparse. In the pixels aligned along the second direction Y, the ratio between the region LC1 and the region LC2 differs from one pixel to another. For example, in the case of the pixel PX1 shown in FIG. 4, where the area overlapping the second transparent layers 42 is relatively large, the proportion of the region LC2 becomes large in the liquid crystal layer LC. Further, in the case of the pixel PX2 shown in FIG. 4, where the area overlapping the second transparent layers 42 is relatively small, the proportion of the region LC1 becomes large in the liquid crystal layer LC. Therefore, when the same voltage is being applied to the pixel PX1 and the pixel PX2, the effective electric field strength applied to the liquid crystal layer LC of the pixel PX1 becomes different from the effective electric field strength applied to the liquid crystal layer LC of the pixel PX2. As a result, even when the light of the same intensity enters the pixel PX1 and the pixel PX2, the luminance of the pixel PX1 becomes different from that of the pixel PX2, resulting in a degradation in display quality.

On the other hand, according to the above-described embodiment, the thickness of the liquid crystal layer LC is substantially constant regardless of the size of the second transparent layers 42. Therefore, when the same voltage is being applied to the pixel PX1 and the pixel PX2, the effective electric field strength applied to the liquid crystal layer LC of the pixel PX1 is substantially the same as the effective electric field strength applied to the liquid crystal layer LC of the pixel PX2. As a result, when the light of the same intensity enters the pixel PX1 and the pixel PX2, the luminance of the pixel PX1 is substantially equal to that of the pixel PX2, and the deterioration in display quality can be suppressed.

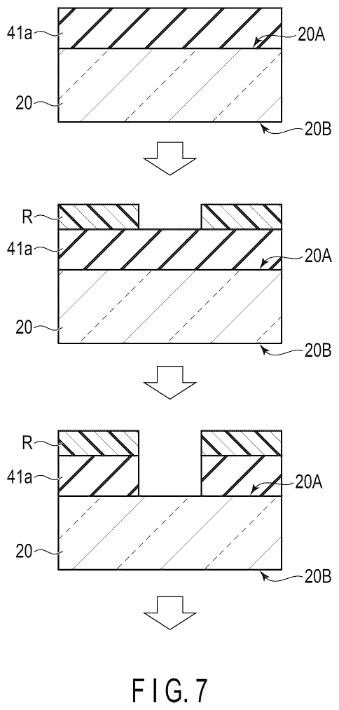

Next, a method of manufacturing the second substrate SUB2 shown in FIG. 2 will be explained. FIGS. 7 to 10 are each a cross-sectional view schematically showing a respective part of the manufacturing process of the second substrate SUB2.

In the manufacturing process for the second substrate SUB2, first, as shown in the upper part of FIG. 7, an inorganic film 41a is formed on the transparent substrate 20 by chemical vapor deposition (CVD) (step P1). In one example, the inorganic film 41a is a silicon dioxide film and is formed to have a thickness of 1 μm or more.

After the step P1, the inorganic film 41a is patterned. In this patterning, as shown in the middle of FIG. 7, a resist R, which is formed to have a predetermined shape, is placed on the inorganic film 41a (step P2). After the step P2, as shown in the lower part of FIG. 7, the portion of the inorganic film 41a that is exposed from the resist R is removed by dry etching using the resist R as a mask (step P3). Specifically, the portion of the inorganic film 41a that corresponds to the grooves 60 is removed, and the main surface 20A is exposed.

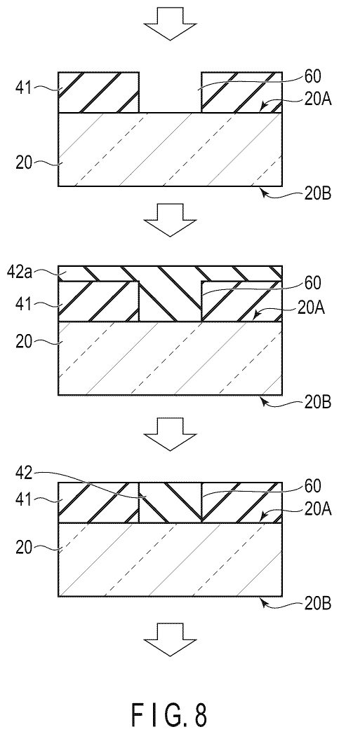

After the step P3, as shown in the upper part of FIG. 8, the resist R is removed (step P4). Thus, the first transparent layer 41 including grooves 60 is formed. After the step P4, as shown in the middle part of FIG. 8, an organic material is applied onto the first transparent layer 41 and in the grooves 60, and the organic material is cured by, for example, irradiating UV light, to form the resin layer 42a (step P5).

After the step P5, as shown in the lower part of FIG. 8, the resin layers 42a and the first transparent layer 41 are polished to expose the first transparent layer 41 and form the second transparent layers 42 (step P6). Here, the polishing is carried out by, for example, chemical polishing, mechanical polishing, chemical mechanical polishing (CMP) and so on.

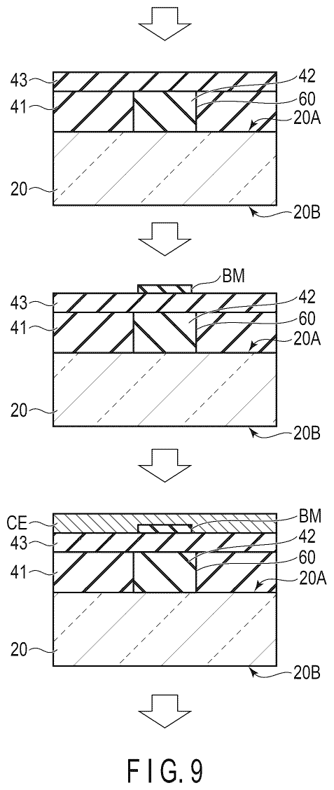

After the step P6, as shown in the upper part of FIG. 9, an organic material is applied onto the first transparent layer 41 and the second transparent layers 42, and the organic material is cured by, for example, irradiating UV light, to form the third transparent layer 43 (step P7). After the step P7, as shown in the middle part of FIG. 9, the light shielding layers BM are formed directly above the second transparent layers 42, respectively (step P8). After the step P8, as shown in the lower part of FIG. 9, the common electrode CE is formed on the third transparent layer 43 and the light shielding layers BM (step P9).

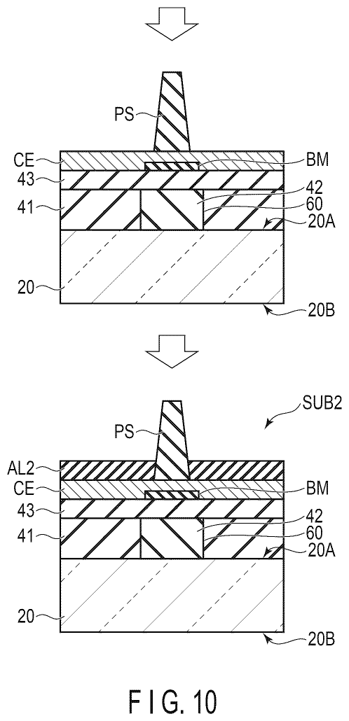

After the step P9, as shown in the upper part of FIG. 10, spacers PS are formed directly above the second transparent layers 42 and light shielding layers BM, respectively (step P10). After the step P10, as shown in the lower part of FIG. 10, an alignment film AL2 is formed on the common electrode CE (step P11). Thus, the second substrate SUB2 is formed.

As explained above, according to this embodiment, it is possible to provide a display device that can suppress a decrease in display quality.

In this embodiment, for example, the transparent substrate 10 corresponds to the first transparent substrate, the transparent substrate 20 corresponds to the second transparent substrate, the transparent substrate 30 corresponds to the third transparent substrate, the pixel electrode PE1 corresponds to the first pixel electrode, and the pixel electrode PE2 corresponds to the second pixel electrode.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A display device comprising:
a first substrate comprising a first transparent substrate and pixel electrodes disposed in a plurality of pixels, respectively, on the first transparent substrate;
a second substrate comprising a second transparent substrate, a common electrode opposing the pixel electrodes, and a transparent layer disposed between the second transparent substrate and the common electrode;
a liquid crystal layer containing stripe-shaped polymers and liquid crystal molecules, and disposed between the first substrate and the second substrate; and
a plurality of light emitting elements arranged along a first direction,
wherein
the transparent layer comprises:
a first transparent layer including a plurality of grooves arranged along the first direction and extending along a second direction perpendicular to the first direction; and
a second transparent layer provided in each of the plurality of grooves,
each of the plurality of grooves has an aperture opposing the liquid crystal layer; and
the second transparent layer has a refractive index lower than those of the second transparent substrate and the first transparent layer.

2. A display device comprising:
a first substrate comprising a first transparent substrate and pixel electrodes disposed in a plurality of pixels, respectively, on the first transparent substrate;
a second substrate comprising a second transparent substrate, a common electrode opposing the pixel electrodes, and a transparent layer disposed between the second transparent substrate and the common electrode;
a liquid crystal layer containing stripe-shaped polymers and liquid crystal molecules, and disposed between the first substrate and the second substrate; and
a plurality of light emitting elements arranged along a first direction,
wherein
the transparent layer comprises:
a first transparent layer including a plurality of grooves arranged along the first direction and extending along a second direction perpendicular to the first direction; and
a second transparent layer provided in each of the plurality of grooves,
the first transparent layer is formed of an inorganic material,
the second transparent layer is formed of an organic material, and
the second transparent layer has a refractive index lower than those of the second transparent substrate and the first transparent layer.

3. The display device of claim 1, wherein
the first transparent layer is formed of silicon dioxide.

4. The display device of claim 2, wherein
the first transparent layer is formed of silicon dioxide.

5. The display device of claim 3, wherein
the first transparent layer has a thickness of 1 μm or more.

6. The display device of claim 4, wherein
the first transparent layer has a thickness of 1 μm or more.

7. The display device of claim 1, wherein
the transparent layer further comprises a third transparent layer covering the first transparent layer and the second transparent layer, and
the third transparent layer is formed of an organic material that is different from that of the second transparent layer and has a refractive index higher than that of the second transparent layer.

8. The display device of claim 2, wherein
the transparent layer further comprises a third transparent layer covering the first transparent layer and the second transparent layer, and
the third transparent layer is formed of an organic material that is different from that of the second transparent layer and has a refractive index higher than that of the second transparent layer.

9. The display device of claim 7, wherein
the second transparent layer is in contact with the second transparent substrate, the first transparent layer, and the third transparent layer.

10. The display device of claim 8, wherein
the second transparent layer is in contact with the second transparent substrate, the first transparent layer, and the third transparent layer.

11. The display device of claim 1, wherein
each of the plurality of grooves comprises a first end portion on a side opposing the light emitting element and a second end portion on an opposite side to the first end portion, and
a width of the first end portion is greater than a width of the second end portion.

12. The display device of claim 2, wherein
each of the plurality of grooves comprises a first end portion on a side opposing the light emitting elements and a second end portion on an opposite side to the first end portion, and
a width of the first end portion is greater than a width of the second end portion.

13. The display device of claim 1, further comprising:
a third transparent substrate comprising a side surface opposing the plurality of light emitting elements,
wherein
the third transparent substrate is adhered to the second transparent substrate.

14. The display device of claim 2, further comprising:
a third transparent substrate comprising a side surface opposing the plurality of light emitting elements,
wherein
the third transparent substrate is adhered to the second transparent substrate.

15. The display device of claim 1, wherein
the first substrate comprises a scanning line, a signal line intersecting the scanning line, and a switching element electrically connected to the scanning line and the signal line, and
the second transparent layer overlaps the signal line in plan view.

16. The display device of claim 2, wherein
the first substrate comprises a scanning line, a signal line intersecting the scanning line, and a switching element electrically connected to the scanning line and the signal line, and
the second transparent layer overlaps the signal line in plan view.

17. The display device of claim 7, wherein
the second substrate further comprises a light shielding layer between the third transparent layer and the common electrode, and
the second transparent layer overlaps the light shielding layer in plan view.

18. The display device of claim 8, wherein
the second substrate further comprises a light shielding layer between the third transparent layer and the common electrode, and
the second transparent layer overlaps the light shielding layer in plan view.

19. The display device of claim 1, wherein
the second substrate further comprises a spacer, and
the second transparent layer overlaps the spacer in plan view.

20. The display device of claim 2, wherein
the second substrate further comprises a spacer, and
the second transparent layer overlaps the spacer in plan view.

21. The display device of claim 1, wherein
the pixel electrodes include a first pixel electrode and a second pixel electrode arranged along the second direction,
the first pixel electrode is located between the second pixel electrode and the plurality of light emitting elements, and
area of the first pixel electrode that overlaps the second transparent layer is larger than area of the second pixel electrode that overlaps the second transparent layer.

22. The display device of claim 2, wherein
the pixel electrodes include a first pixel electrode and a second pixel electrode arranged along the second direction,
the first pixel electrode is located between the second pixel electrode and the plurality of light emitting elements, and
area of the first pixel electrode that overlaps the second transparent layer is larger than area of the second pixel electrode that overlaps the second transparent layer.
